(19) United States
(12) Patent Application Publication
(10) Pub. No.: US 2008/0082318 A1
(43) Pub. Date: Apr. 3, 2008

(54) Semantic retrieval method and computer product

(75) Inventors: Masahiro Kataoka, Kawasaki (JP); Takashi Furuta, Kawasaki (JP); Koichi Takahashi, Kawasaki (JP); Takashi Tsubokura, Minato-ku (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/974,184

(22) Filed: Oct. 11, 2007

Related U.S. Application Data
(63) Continuation of application No. PCT/JP2006/307563, filed on Apr. 10, 2006.

(30) Foreign Application Priority Data
Apr. 12, 2005 (JP) 2005-114909

(51) Int. Cl. G06F 17/27

(52) U.S. Cl. 704/9; 704/E15.024

(57) ABSTRACT

A dictionary server includes a retrieval-display processing unit. Upon receipt of a request for retrieval of semantic information related to a term from a client PC, the retrieval-display processing unit acquires the semantic information, header information, and link information related to the semantic information from knowledge reference data, dictionary content data, and dictionary data. Based on the acquired information, the retrieval-display processing unit causes the client PC to display items on webpage related to the semantic information, the header information, and the link information.

This is a continuation under 35 U.S.C. § 111(a) of International Application No. PCT/JP2006/307563, filed Apr. 10, 2006.

### BACKGROUND OF THE INVENTION

1. Field of the Invention

The present invention relates to a technology of semantic retrieval.

2. Description of the Related Art

In recent years, various websites exist on the Internet. Website users access such websites and acquire information through a terminal such as a cellular phone and a personal computer.

The website users include users in research and development departments involved in specific business. Such users access business webpages including information related to contents of the business, acquire business manual information, production information, and the like, and perform research and product development.

However, the business manual information and the production information include various terms that the users cannot understand. Every time the users find a term that they cannot understand, the users need to access website where information on the term can be retrieved (hereinafter, “dictionary retrieval sites”).

Japanese Patent Application Laid-Open No. 2002-92037 discloses a technology for allowing a user to easily retrieve a term that the user cannot understand included in a business webpage by establishing a link from the business webpage to a dictionary retrieval site on the Internet and using the dictionary retrieval site at the link destination.

However, in the conventional technology, even if a website user belonging to a research and development department retrieves terms and the like on the business webpage using the dictionary retrieval site, efficiency of business related to research and development and the like cannot be improved.

This is because, when the user retrieves a term using the dictionary retrieval site, the user can understand only a meaning of the term because of copyright protection and cannot refer to examples of successes and failures of the user's own company on a business webpage related to the retrieved term. As a result, improvement of business efficiency through synergy effect cannot be realized.

### SUMMARY OF THE INVENTION

It is an object of the present invention to at least partially solve the problems in the conventional technology.

According to an aspect of the present invention, a semantic retrieval method includes storing link information on a link to information related to semantic information; receiving a request for retrieval of semantic information related to an item; retrieving the semantic information; retrieving link information related to the semantic information; and outputting the semantic information and the link information.

According to another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a dictionary retrieval system according to a first embodiment of the present invention;

FIG. 2 is a functional block diagram of a dictionary server shown in FIG. 1;

FIG. 3 is a functional block diagram of a retrieval-display processing unit shown in FIG. 2;

FIG. 4 is an example of a data structure of knowledge reference data shown in FIG. 3;

FIG. 5 is an example of a data structure of header data;

FIG. 6 is an example of a data structure of text HTML data;

FIG. 7 is an example of a screen displayed on a client PC shown in FIG. 1;

FIG. 8 is an example of a screen displayed when a user clicks an item on the screen shown in FIG. 7;

FIG. 9 is an example of a reference-registration screen;

FIG. 10 is an example of a destination-registration screen;

FIG. 11 is an example of an additional registration screen;

FIG. 12 is an example of a data structure of new item data;

FIG. 13 is an example of a screen displaying keywords in the news;

FIG. 14 is an example of a data structure of access log data;

FIG. 15 is a flowchart of a processing procedure performed by the dictionary server according to the first embodiment;

FIG. 16 is a schematic diagram of a dictionary retrieval system according to a second embodiment of the present invention;

FIG. 17 is a functional block diagram of a dictionary server shown in FIG. 16;

FIG. 18 is an example of a data-structure of track-back information received by a track-back receiving unit shown in FIG. 17;

FIG. 19 is an example of a data structure of update information received by the track-back receiving unit;

FIG. 20 is a schematic diagram of a dictionary retrieval system according to a third embodiment of the present invention;

FIG. 21 is an example of link data stored by a CMS shown in FIG. 20;

FIG. 22 is a functional block diagram of a dictionary server shown in FIG. 20;

FIG. 23 is a schematic diagram of a dictionary retrieval system according to a fourth embodiment of the present invention;

FIG. 24 is an example of reference-history data stored in a client PC shown in FIG. 23;

FIG. 25 is a functional block diagram of a dictionary server shown in FIG. 23;

FIG. 26 is a schematic diagram of a dictionary retrieval system according to a fifth embodiment of the present invention;

FIG. 27 is a functional block diagram of a dictionary server shown in FIG. 26;

FIG. 28 is an example of a data structure of monitoring-target data shown in FIG. 27; and

FIG. 29 is a schematic diagram of a computer that executes a semantic retrieval program.

### DETAILED DESCRIPTION OF THE PREFERRED EMBODIMENTS

Exemplary embodiments of the present invention are explained in detail below.

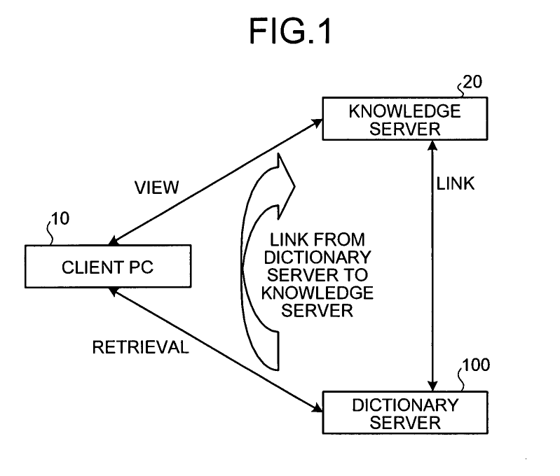

FIG. 1 is a schematic diagram of a dictionary retrieval system according to the first embodiment. The dictionary retrieval system includes a client PC 10, a knowledge server 20, and a dictionary server 100. The client PC 10, the knowledge server 20, and the dictionary server 100 are connected to one another through a network or the like. A link is established from a site opened by the dictionary server 100 to a site opened by the knowledge server 20.

The dictionary server 100 stores therein information concerning meanings (hereinafter, “semantic information”) of predetermined matters or items and link information of business webpages related to this semantic information in association with each other. When a request for dictionary retrieval of a certain item is received, the dictionary server 100 displays a list of business webpages based on the semantic information and the link information corresponding to the item, for which the request for dictionary retrieval is received.

The client PC 10 is used for accessing the dictionary server 100 or the knowledge server 20 to request the dictionary server 100 or the knowledge server 20 to perform dictionary retrieval of a term and viewing a business webpage related to semantic information of the term.

The knowledge server 20 manages a business webpage for publishing information related to business and the like. The knowledge server 20 transmits, when a view request is received from the client PC 10, information corresponding to the view request to the client PC 10. The knowledge server 20 transmits, when contents and the like of the business webpage are updated, update information including the updated contents to the dictionary server 100 at the link source.

The dictionary server 100 stores therein semantic information and link information related to the semantic information in association with each other and displays, when a request for dictionary retrieval of a term is received from the client PC 10, semantic information and items of a business webpage based on link information corresponding to the request. The dictionary server 100 reflects, when update information is received from the knowledge server 20, the received update information and notifies a user of the update information.

In this way, the dictionary server 100 displays, when the request for dictionary retrieval of a term is received from the client PC 10, not only a meaning of the term but also items of a business webpage related to the term. Thus; a website user can easily acquire extensive information concerning the term and can improve business efficiency.

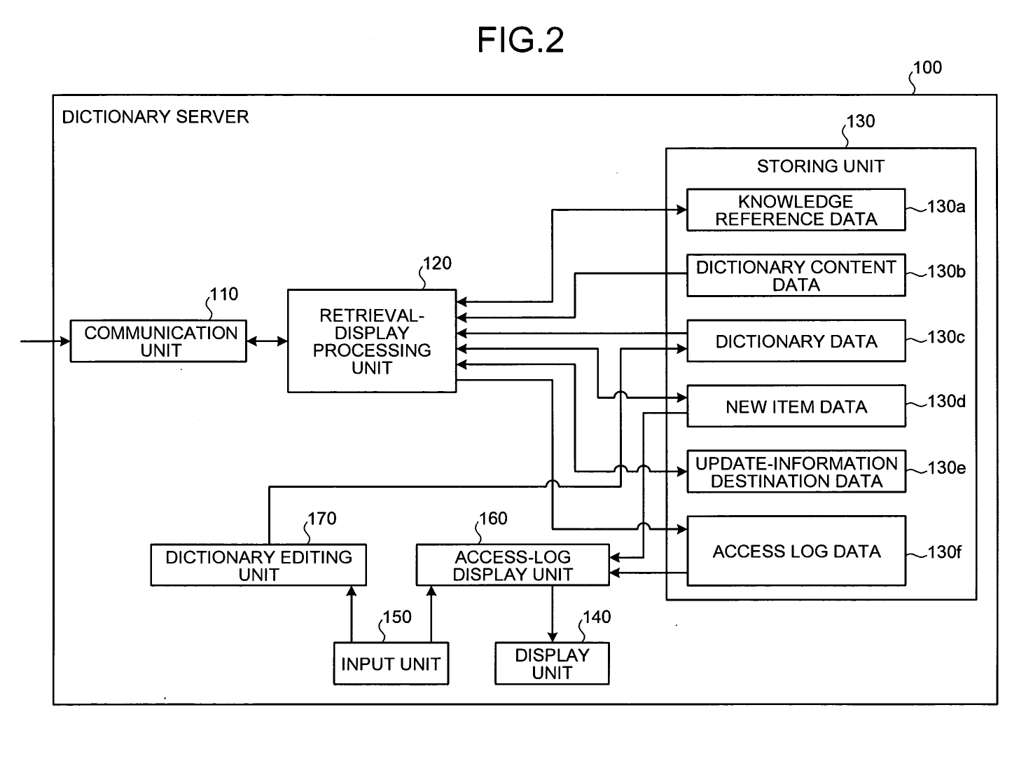

FIG. 2 is a functional block diagram of the dictionary server 100. The dictionary server 100 includes a communication unit 110, a retrieval-display processing unit 120, a storing unit 130, a display unit 140, an input unit 150, an access-log display unit 160, and a dictionary editing unit 170.

The communication unit 110 communicates with the client PC 10 and the knowledge server 20 using a predetermined communication protocol. The retrieval-display processing unit 120 retrieves a term requested by the client PC 10 from a dictionary using respective data stored in the storing unit 130 and causes the client PC 10 to display items of a business webpage related to the term for which the dictionary retrieval is performed.

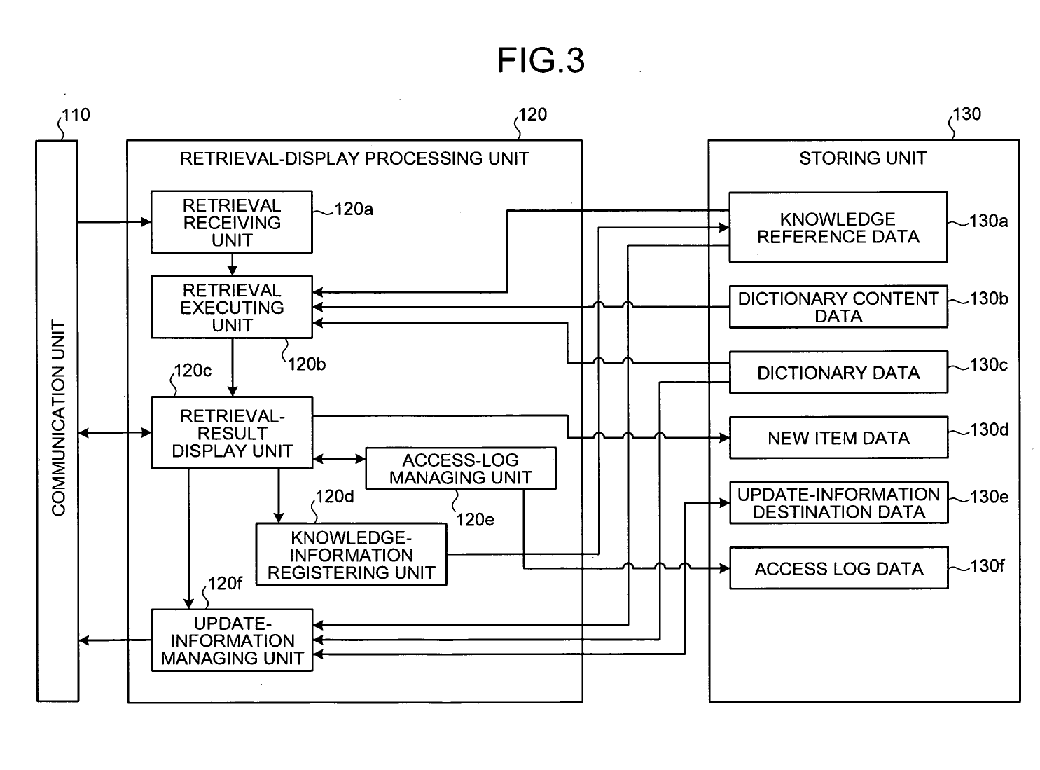

FIG. 3 is a functional block diagram of the retrieval-display processing unit 120. The retrieval-display processing unit 120 includes a retrieval receiving unit 120a, a retrieval executing unit 120b, a retrieval-result display unit 120c, a knowledge-information registering unit 120d, an access-log managing unit 120e, and an update-information managing unit 120f.

The retrieval receiving unit 120a is accessed from the client PC 10 and causes the client PC 10 to display a screen for performing dictionary retrieval. The retrieval receiving unit 120a passes, when a term as a retrieval object is input, information on the input term (hereinafter, “input term information”) to the retrieval executing unit 120b.

The retrieval executing unit 120b acquires the input term information from the retrieval receiving unit 120a, retrieves semantic information corresponding to the acquired input term information and header information related to the semantic information from dictionary content data 130b or dictionary data 130c, and retrieves link information corresponding to the semantic information from knowledge reference data 130a. The retrieval executing unit 120b passes the retrieved semantic information, header information, and link information to the retrieval-result display unit 120c. The retrieval executing unit 120b notifies, when semantic information corresponding to the input term information is not present, the retrieval-result display unit 120c that the semantic information is not present.

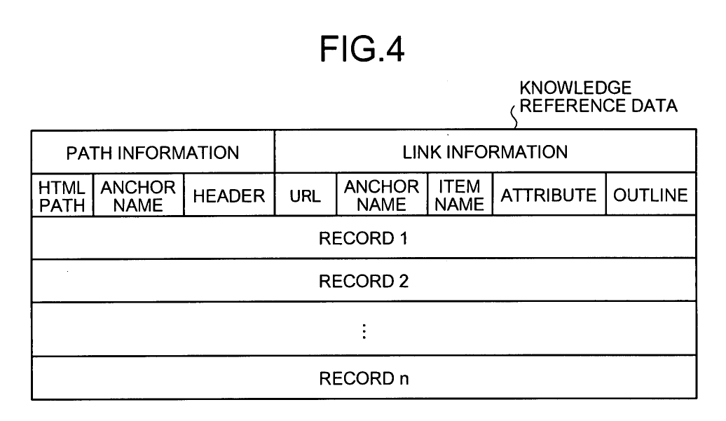

FIG. 4 is an example of a data structure of the knowledge reference data 130a. As shown in FIG. 4, the knowledge reference data 130a includes path information and link information in association with each other. The path information is information for specifying semantic information-stored in the dictionary content data 130b or the dictionary data 130c.

The path information includes Hyper Text Markup Language (HTML) path, anchor name, and header. The link information includes Uniform Resource Locator (URL), anchor name, item name, attribute (information such as synonym, antonym, related term, and example corresponding to semantic information), and outline. In the knowledge reference data 130a, records 1 to n corresponding to the path information and the link information are recorded.

The retrieval executing unit 120b retrieves, when semantic information is retrieved from the dictionary content data 130b or the dictionary data 130c, a record corresponding to the retrieved semantic information using the path information (HTML path, anchor name, and header) as a key. The retrieval executing unit 120b acquires link information included in the retrieved record as link information related to the semantic information.

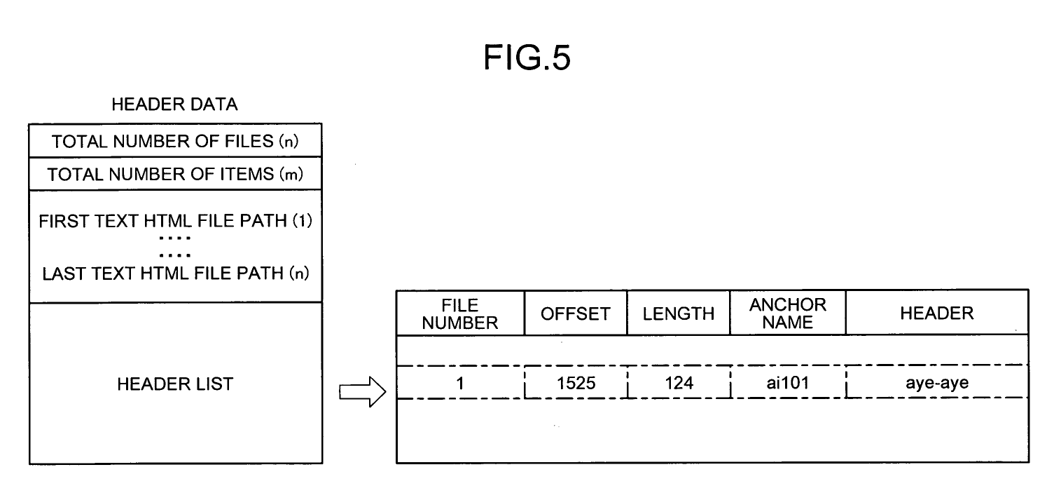

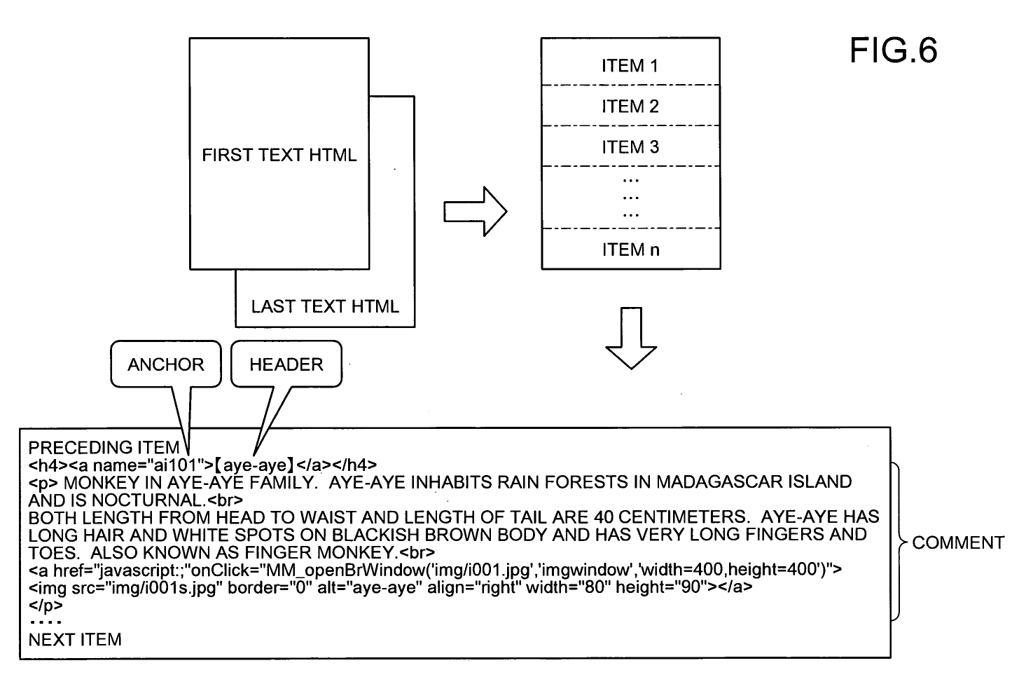

The dictionary content data 130b includes header data and text HTML data. FIG. 5 is an example of a data structure of the header data. FIG. 6 is an example of a data structure of the text HTML data. As shown in FIG. 5, the header data includes the total number of files, the total number of items, text HTML file paths (first to last text HTML file paths), and header list.

The header list includes such items as file number, offset (address information), length (data length), anchor name, and header. Specifically, concerning a file number “1”, the offset is “1525”, the length is “124”, the anchor name is “ai101”, and the header is “aye-aye”.

Referring to FIG. 6, the text HTML data (first to last text HTML data) include a plurality of items 1 to n. Each of the items include anchor, header, and comment (semantic information). A data structure of the dictionary data 130c is basically the same as that of the dictionary content data 130b, and the same explanation is not repeated.

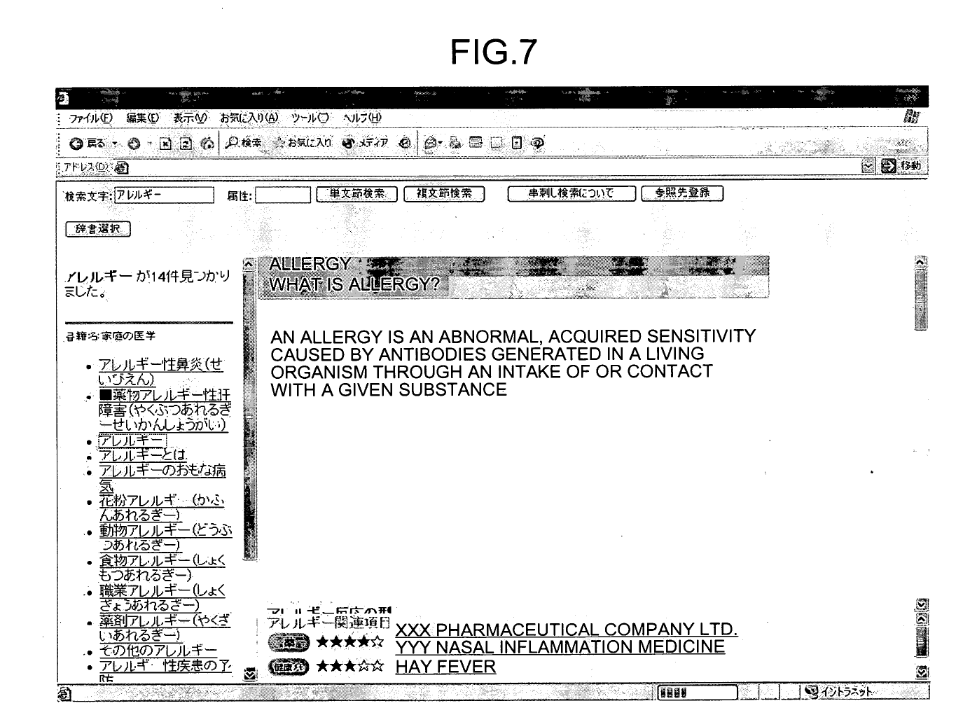

The retrieval-result display unit 120c acquires semantic information, header information, and link information, and causes the client PC 10 to display items of a business webpage related to the semantic information, the header information, and the link information. FIG. 7 is an example of a display screen that the retrieval-result display unit 120c causes the client PC 10 to display.

As shown in FIG. 7, the client PC 10 displays selected items according to the header information, information corresponding to the semantic information (in FIG. 7, “An allergy is . . . ”), and items of a business webpage according to the link information (in FIG. 7, “XXX Pharmaceutical Company Ltd., YYY nasal inflammation medicine”, “hay fever”).

When the user accesses the dictionary server 100 and requests dictionary retrieval of a term, for example, “allergy” using the client PC 10, the user can efficiently view not only a meaning of the term “allergy” but also the business webpage related to the allergy and can improve business efficiency.

The retrieval-result display unit 120c can display attribute information (synonym, antonym, related term, example, etc.) together with the items of the business webpage according to the link information. The user can efficiently refer to a desired business webpage by displaying the attribute information together with the items of the business webpage in this way.

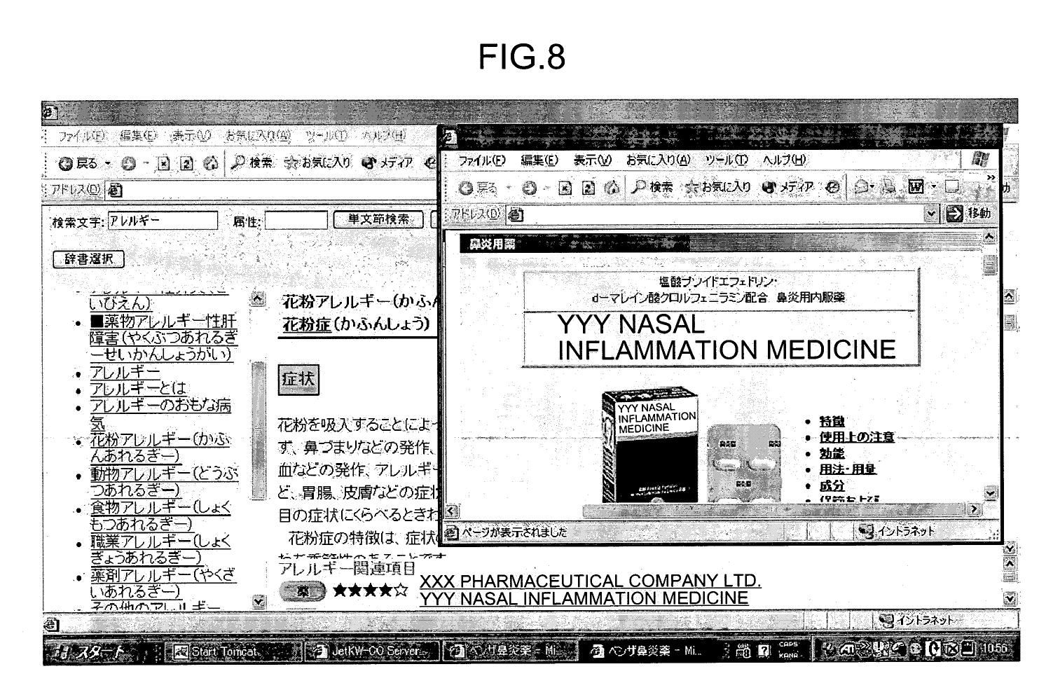

FIG. 8 is an example of a screen displayed when the user clicks the item “XXX Pharmaceutical Company Ltd., YYY nasal inflammation medicine” on the display screen in FIG. 7. The retrieval-result display unit 120c can display, when the display screen is displayed, URL information for directly referring to information corresponding to the semantic information together with the display screen. When notification indicating that semantic information corresponding to the input term information is not present is received from the retrieval executing unit 120b, the retrieval-result display unit 120c displays to that effect.

When information related to a link destination of a new business webpage (hereinafter, “registered link information”) is acquired from the client PC 10, the retrieval-result display unit 120c passes the acquired registered link information to the knowledge-information registering unit 120d.

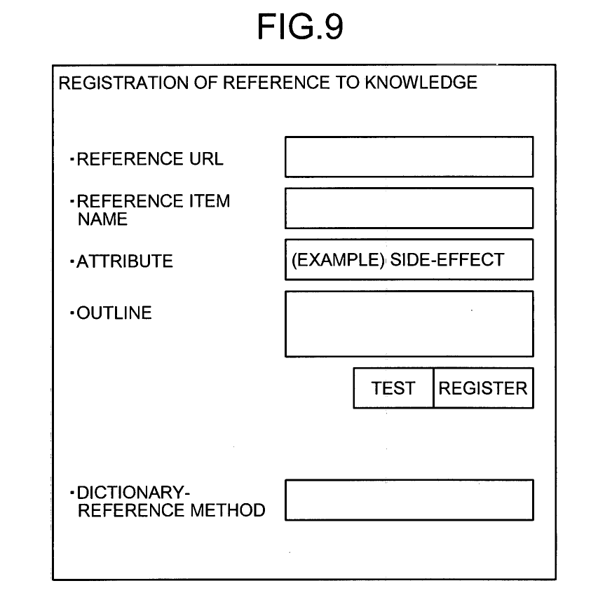

Specifically, the retrieval-result display unit 120c causes the client PC 10 to display the screen shown in FIG. 7 and causes, when a “reference register” button is clicked, the client PC 10 to display a reference-registration screen. FIG. 9 is an example of the reference-registration screen.

The retrieval-result display unit 120c passes data input through the reference-registration screen (reference URL, reference item name, attribute, outline, and dictionary-reference method) to the knowledge-information registering unit 120d as registered link information. URL information and the like for referring to other dictionary servers are input in the “dictionary-reference method”.

In this way, the retrieval executing unit 120b can easily request a plurality of different dictionary servers to perform dictionary retrieval of a term by acquiring the URL information for referring to other dictionary servers and using the acquired URL information. Thus, it is possible to improve business efficiency for the user.

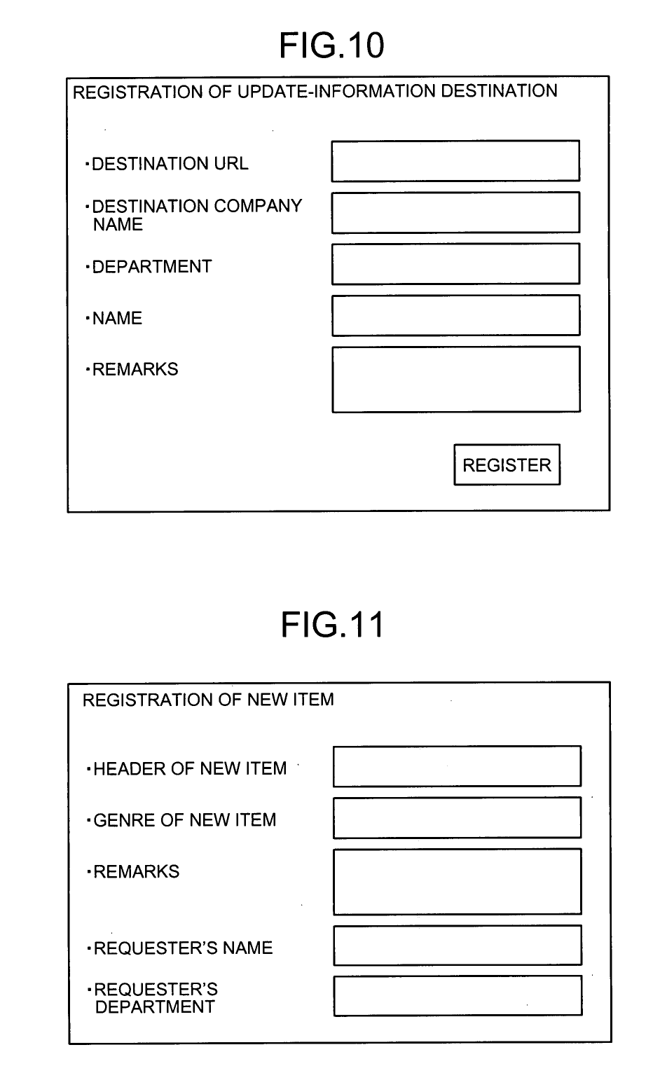

When a registration request for an update-information destination is received, the retrieval-result display unit 120c causes the client PC 10 to display a destination-registration screen for registration of an update-information destination. FIG. 10 is an example of the destination-registration screen.

When information on an update-information destination (destination URL, destination company name, department, name, and remarks) are input through the destination-registration screen, and “register” is clicked, the retrieval-result display unit 120c passes the information to the update-information managing unit 120f as destination-registration information. An email address of the user can be used instead of the destination URL.

When a request for addition of a new item is received, the retrieval-result display unit 120c causes the client PC 10 to display an additional registration screen. FIG. 11 is an example of the additional registration screen.

The retrieval-result display unit 120c registers, when information on a new item are input through the additional registration screen shown in FIG. 11, the information (header of new item, genre of new item, remarks, requester's name, and requester's department) in the storing unit 130 as new item data 130d.

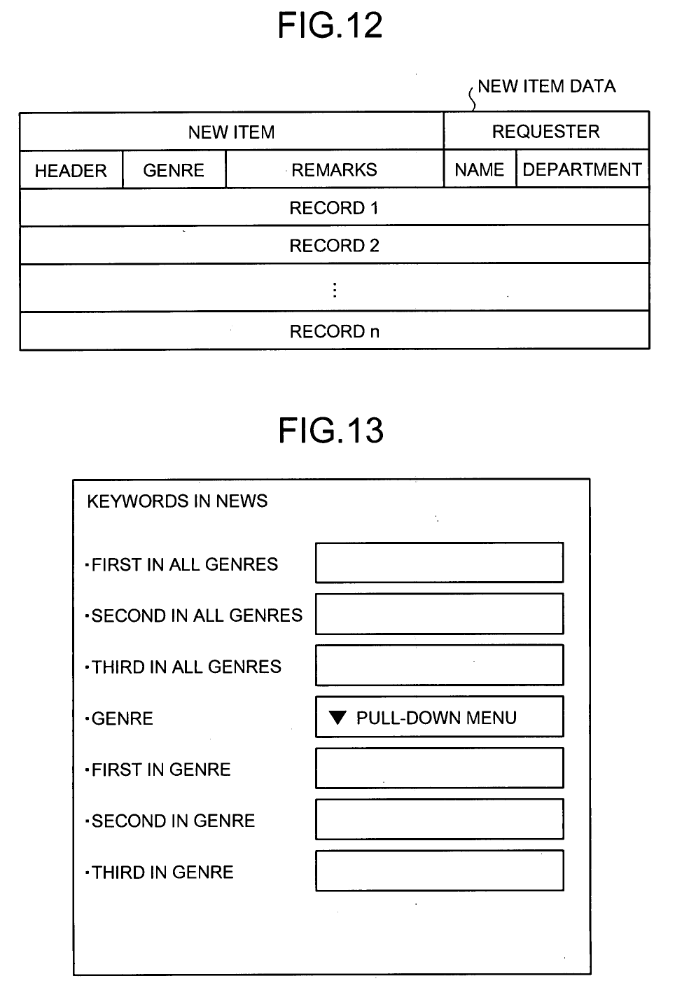

FIG. 12 is an example of a data structure of the new item data 130d. As shown in FIG. 12, the new item data 130d includes header, genre, remarks, name, and department. Records 1 to n corresponding to respective pieces of information are recorded in the new item data 130d.

When requested to display keywords in the news, the retrieval-result display unit 120c requests the access-log managing unit 120e to provide information concerning the keywords in the news and displays the information.

FIG. 13 is an example of a screen displaying keywords in the news. As shown in FIG. 13, the screen displays terms ranked first to third in all genres and terms ranked first to third in each of the genres requested for retrieval a larger number of times among terms for which requests for retrieval have been received.

The knowledge-information registering unit 120d acquires semantic information and registered link information from the retrieval executing unit 120b and records information in the knowledge reference data 130a based on the acquired information. Specifically, the knowledge-information registering unit 120d converts the semantic information and the registered link information into path information and link information, respectively, and records the converted data in the knowledge reference data 130a.

The access-log managing unit 120e manages, for example, access history to the dictionary server 100. Specifically, the access-log managing unit 120e classifies, for example, the number of times of retrieval of the terms, for which requests for dictionary retrieval are received, by genre and stores the number of times of retrieval and the like as information concerning keywords in the news. When a request for information concerning keywords in the news is received from the retrieval-result display unit 120c, the access-log managing unit 120e passes the stored information concerning keywords in the news to the retrieval-result display unit 120c.

When the retrieval-result display unit 120c displays items related to the semantic information, the access-log managing unit 120e creates access log data 130f based on a state of selection of the displayed items by the user.

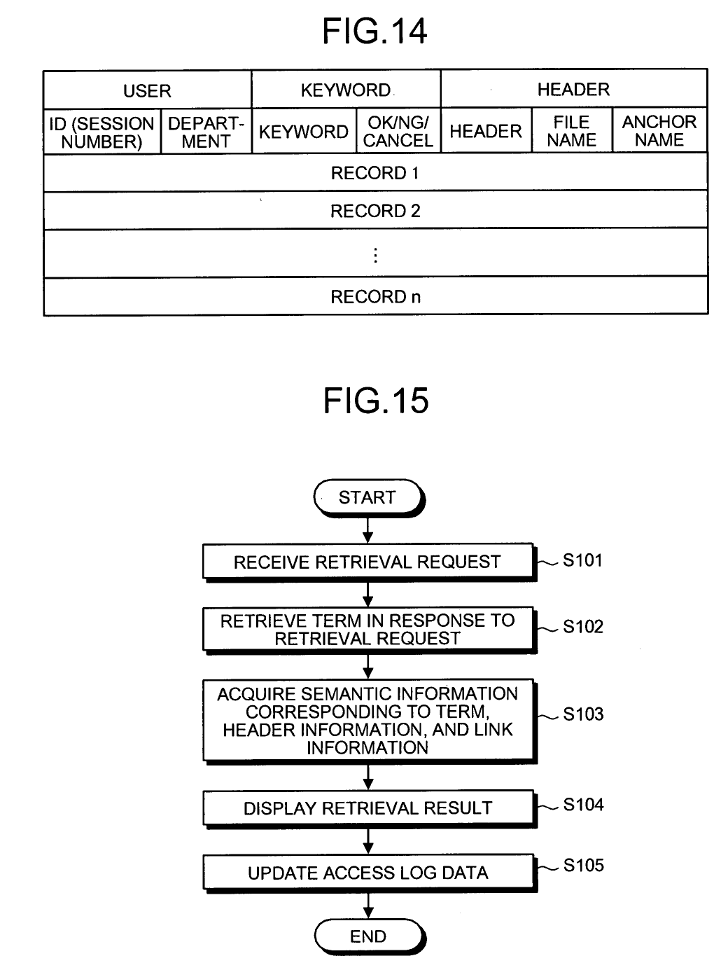

FIG. 14 is an example of a data structure of the access log data 130f. As shown in FIG. 14, the access log data 130f includes ID (session number), department, keyword (terms and the like), OK/NG/Cancel, header, file name, and anchor name. Records 1 to n corresponding to respective pieces of information are recorded in the access log data 130f.

“NG” indicates that a candidate of a header corresponding to input term information is not present. “Cancel” indicates that, although an item of a header is displayed, the displayed item is not selected. “OK” indicates that, when a header is displayed, the displayed item is selected. A plurality of variations can be provided for “OK”.

For example, when a plurality of items are displayed, “OK1” indicates that a first item is selected, “OK2” indicates that items in the middle are selected, and “OK3” indicates that a last item is selected.

The update-information managing unit 120f records, when destination-registration information is acquired from the retrieval-result display unit 120c, the acquired destination-registration information in update-information destination data 130e. When data recorded in the knowledge reference data 130a and the dictionary data 130c are updated, the update-information managing unit 120f notifies a user recorded in the update-information destination data 130e of the updated data.

Referring back to FIG. 2, the display unit 140 causes a display or the like to display information acquired from the access-log display unit 160. The input unit 150 passes information received through an input device such as a keyboard to the access-log display unit 160 or the dictionary editing unit 170.

The access-log display unit 160 passes, when a request for display of access log data or new item data is received from the input unit 150, information corresponding to the request to the display unit 140. Specifically, when the access-log display unit 160 receives a request for display of access log data from the input unit 150, the access-log display unit 160 passes data recorded in the access log data 130f to the display unit 140. When a request for display of new item data is received from the input unit 150, the access-log display unit 160 passes data recorded in the new item data 130d to the display unit 140.

When an administrator of the dictionary server 100 refers to the new item data, keywords indicated by NG in the access log data, and the like via the display, the administrator can acquire the dictionary content data 130b by inputting semantic information or the like corresponding to the new item data or the keywords indicated by NG to the dictionary server 100.

The dictionary editing unit 170 registers, when semantic information and header information related to the semantic information are received from the input unit 150, the acquired semantic information and header information in the dictionary data 130c.

In this way, when the semantic information and the header information are acquired from the input unit 150, the dictionary editing unit 170 records the semantic information and the header information in the dictionary data 130c rather than updating the dictionary content data 130b. Thus, it is possible to acquire information in the dictionary content data 130b while preventing the problem of copyright protection for the dictionary content data 130c.

FIG. 15 is a flowchart of a processing procedure performed by the dictionary server 100. As shown in FIG. 15, in the dictionary server 100, the retrieval-display processing unit 120 receives a retrieval request (step S01), and retrieves a term from a dictionary in response to the retrieval request (step S102).

The retrieval-display processing unit 120 acquires semantic information, header information, and link information from the knowledge reference data 130a, the dictionary content data 130b, and the dictionary data 130c (step S103), displays a retrieval result (step S104), and updates the access log data (step S105).

In this manner, the retrieval-display processing unit 120 displays, when a retrieval request is received, not only a result of dictionary retrieval of a term requested to be retrieved but also items of a business webpage related to the term. Thus, the user can realize efficiency of business.

As described above, when the dictionary server 100 receives a request for dictionary retrieval of a predetermined term from the client PC 10, the retrieval-display processing unit 120 acquires semantic information, header information, and link information related to the semantic information corresponding to the term from the knowledge reference data 130a, the dictionary content data 130b, and the dictionary data 130c. The retrieval-display processing unit 120 causes the client PC 10 to display terms of a business webpage related to the semantic information, header information, and the link information based on the acquired respective kinds of information. Thus, the user can efficiently refer to not only a meaning of a term for which dictionary retrieval is performed but also a business webpage related to the term and can improve business efficiency.

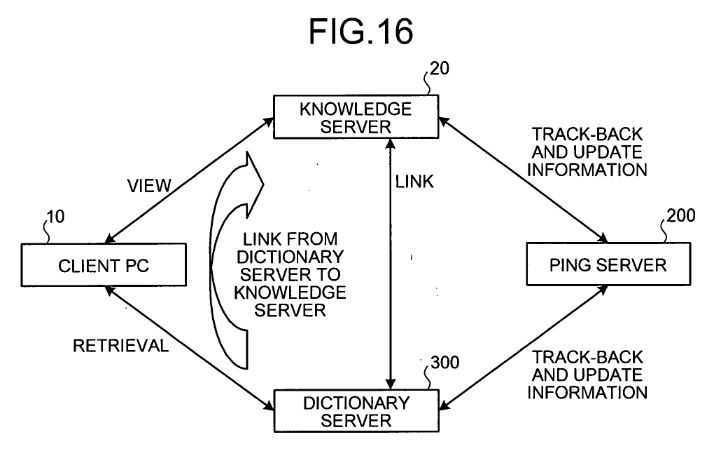

FIG. 16 is a schematic diagram of a dictionary retrieval system according to a second embodiment of the present invention. As shown in FIG. 16, the dictionary retrieval system includes the client PC 10, the knowledge server 20, a PING server 200, and a dictionary server 300.

The dictionary server 300 displays, when a request for dictionary retrieval of a certain item is received, a list of items of a business webpage based on semantic information and link information corresponding to the matter, for which the request for dictionary retrieval is received.

The dictionary server 300 exchanges track-back information with the knowledge server 20 at the link destination (for the exchange of the track-back information, the PING server 200 is used) and updates information and the like concerning a business webpage using a Weblog function. The track-back information is information for establishing a link between a transmission source and a transmission destination.

The PING server 200 transmits, when track-back information is acquired from the knowledge server 20, the acquired track-back information to a transmission destination registered in advance. In the second embodiment, when track-back information (or update information) is acquired from the knowledge server 20, the PING server 200 transmits the acquired track-back information to the dictionary server 300. When track-back information (or update information) is acquired from the dictionary server 300, the PING server 200 transmits the acquired track-back information to the knowledge server 20.

The client PC 10 and the like can prevent important private data and the like from being transmitted to a third party by limiting transmission destinations of the track-back information of the PIN server 200.

The dictionary server 300 stores therein semantic information and link information related to the semantic information in association with each other and displays, when a request for dictionary retrieval of a term is received from the client PC 10, terms of a business webpage based on semantic information and link information corresponding to the request. When track-back information is received from the knowledge server 20, the dictionary server 300 converts the acquired track-back information into link information concerning a link to the knowledge server 20.

When an update information request based on an RDF <Resource Description Framework> Site Summary (RSS) is received from the client PC 10, the dictionary server 300 transmits updated information to the client PC 10. Since explanation concerning the client PC 10 and the knowledge server 20 is the same as that in the first embodiment, the explanation is omitted.

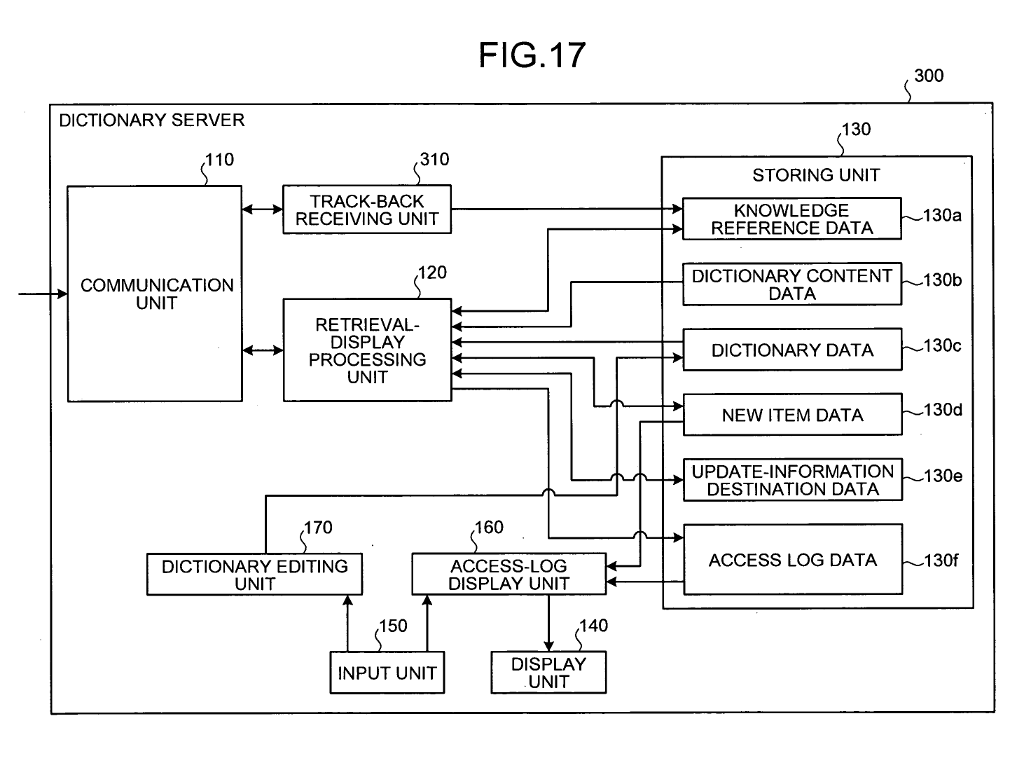

FIG. 17 is a functional block diagram of the dictionary server 300. The dictionary server 300 is of basically the same configuration as the dictionary server 100 except for a track-back receiving unit 310, and the same explanation is not repeated.

The track-back receiving unit 310 converts, when track-back information is received, the received track-back information into link information and records the converted information in the knowledge reference data 130a.

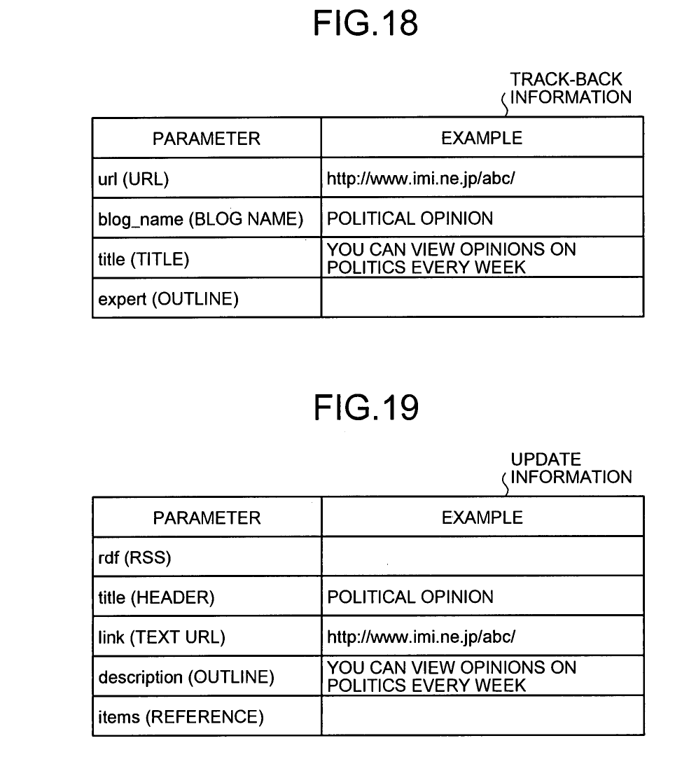

FIG. 18 is an example of a data structure of track-back information received by the track-back receiving unit 310. As shown in FIG. 18, the track-back information includes url (URL), blog_name (blog name), title (title), and expert (outline). For example, “http://www.imi.ne.jp/abc/” is set in the url, “Political Opinion” is set in the blog name, and “you can view opinions on politics every week” is set in the title (a specific example of the expert is omitted).

When contents of the knowledge reference data 130 are updated by the retrieval-display processing unit 120, the track-back receiving unit 310 transmits track-back information to the knowledge server at a link destination to which link is established anew.

When update information is received from the knowledge server 20, the track-back receiving unit 310 updates the knowledge reference data 130a based on the received update information. FIG. 19 is an example of a data structure of update information received by the track-back receiving unit 310.

As shown in FIG. 19, the update information includes rdf (RSS), title (header), link (text header), description (outline), and items (reference). For example, “Political Opinion” is set in the title, “http://www.imi.ne.jp/abc/” is set in the link, and “you can view opinions on politics every week” is set in the description.

When an update information request based on the RSS is received from the client PC 10, the retrieval-display processing unit 120 transmits updated information to the client PC 10 based on the update-information destination data 130e.

As described above, in the dictionary server 300, when a request for dictionary retrieval of a term is received from the client PC 10, the retrieval-display processing unit 120 causes the client PC 10 to display not only semantic information of the term but also items of a business webpage related to link information related to the semantic information. When receiving track-back information from the knowledge server 20, the track-back receiving unit 310 converts the track-back information into link information and records the link information in the knowledge reference data 130a. Thus, it is possible to establish a link to a webpage opened by the knowledge server 20.

The administrator of the knowledge server 20 can efficiently acquire a term retrieved by a user by referring to the track-back information transmitted from the dictionary server 300. Thus, it is possible to improve business efficiency for research and development and the like.

In the first and second embodiments, the dictionary server and the knowledge server are associated with each other. However, the present invention is not limited to this. For example, the dictionary server and an e-learning system can be associated with each other. In other words, when a request for dictionary retrieval of a term is received from the client PC, the dictionary server can display link information concerning a link to a webpage related to the e-learning system as well.

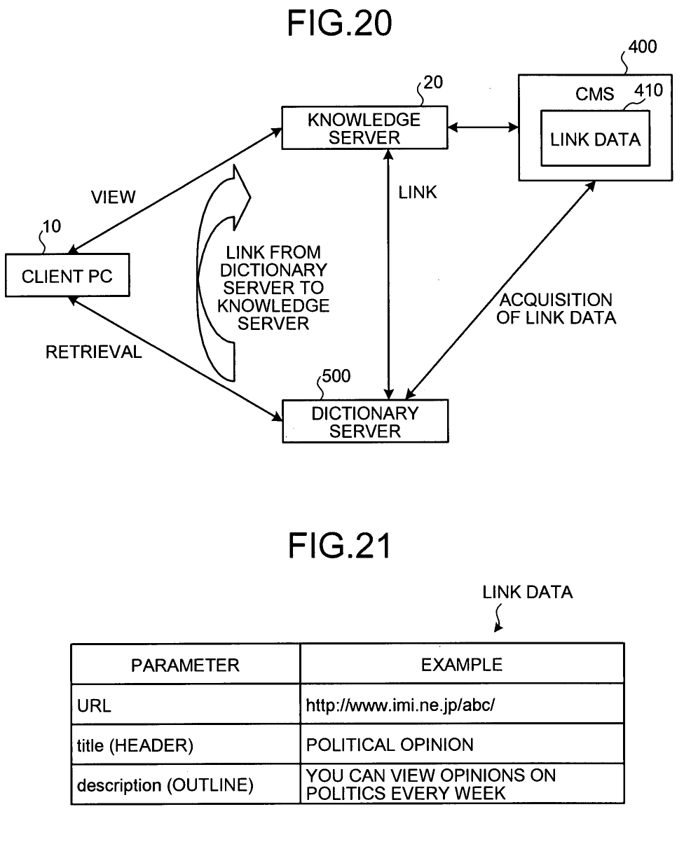

FIG. 20 is a schematic diagram of a dictionary retrieval system according to a third embodiment of the present invention. As shown in FIG. 20, the dictionary retrieval system includes the client PC 10, the knowledge server 20, a contents management system (CMS) 400, and a dictionary server 500.

The dictionary server 500 displays, when a request for dictionary retrieval of a certain item is received, a list of items of a business webpage based on semantic information and link information corresponding to the matter, for which the request for dictionary retrieval is received.

The dictionary server manages various data (texts, images, layout information, etc.) for establishing a business webpage, acquires link information concerning a link from the business webpage to a retrieval site of semantic information from the CMS 400 that establishes the business webpage, and generates link information concerning a link from the semantic information to the business webpage based on the link information.

When a request for dictionary retrieval of a certain item is received, the dictionary server 500 displays, based on the generated link information, semantic information and a list of items of a business webpage corresponding to the matter, for which the request for dictionary retrieval is received.

The CMS 400 manages various data (texts, images, layout information, etc.) for establishing a website such as a business webpage and establishes a website. The CMS 400 stores link data 410 including link information concerning a link from a website such as a business webpage to a retrieval site for semantic information.

FIG. 21 is an example of the link data 410 stored by the CMS 400. As shown in FIG. 21, in the link data 410 is registered information on URL, title (header), and description (outline). For example, “http://www.imi.ne.jp/abc/” is set in the URL, “Political Opinion” is set in the title (header), and “you can view opinions on politics every week” is set in the description (outline).

The URL is a URL of a business webpage in which the CMS 400 manages data. In this business webpage, a link to a retrieval site for semantic information is set. The title (header) is information concerning a title (header) set in the business webpage. The description (outline) is information concerning an outline of the business webpage.

The dictionary server 500 stores therein semantic information and link information related to the semantic information in association with each other and displays, when a request for dictionary retrieval of a term is received from the client PC 10, items of a business webpage based on semantic information and link information corresponding to the request.

The dictionary server 500 acquires, from the CMS 400, URL information of the business webpage, in which a link to the retrieval site for semantic information is set, and generates link information concerning a link from the semantic information to the business webpage based on the URL information.

When a request for dictionary retrieval of a certain matter is received, the dictionary server 500 displays semantic information and a list of items of a business webpage corresponding to the matter, for which the request for dictionary retrieval is received. Since explanation concerning the client PC 10 and the knowledge server 20 is the same as that in the first embodiment, the explanation is omitted.

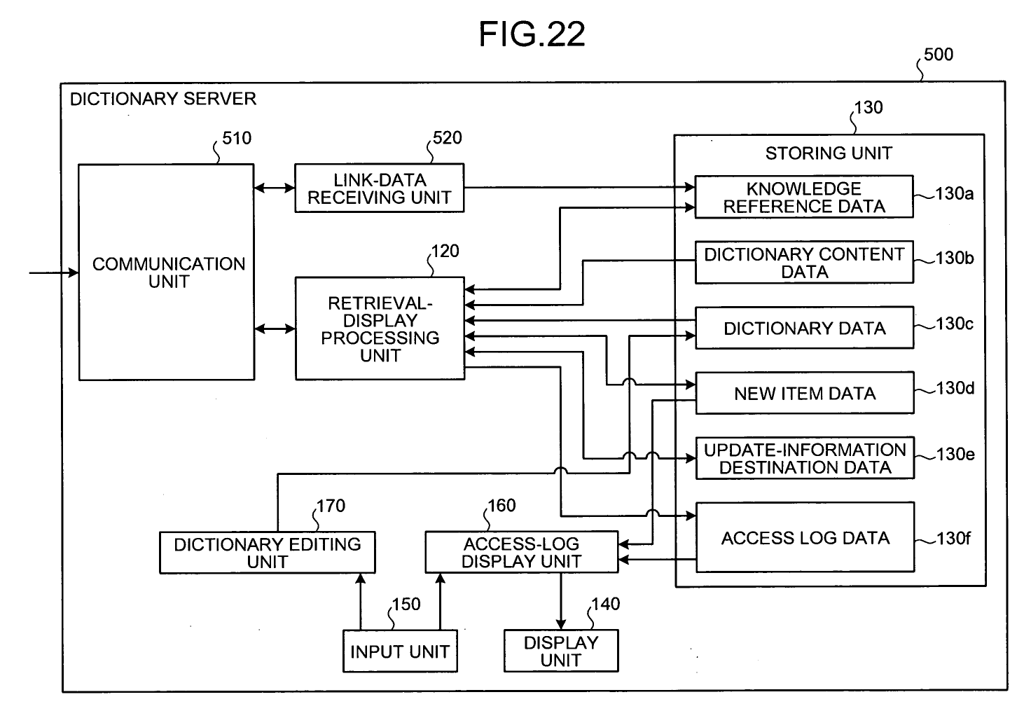

FIG. 22 is a functional block diagram of the dictionary server 500. The dictionary server 500 is of basically the same configuration as the dictionary server 100 except for a communication unit 510 and a link-data receiving unit 520, and the same explanation is not repeated.

The communication unit 510 communicates with the client PC 10, the knowledge server 20, and the CMS 400 using a predetermined communication protocol. The link-data receiving unit 520 acquires the link data 410 from the CMS 400, generates update information having a data structure same as that of the update information shown in FIG. 19, and updates the knowledge reference data 130a based on the generated update information.

Specifically, the link-data receiving unit 520 sets information on URL, title (header), and description (outline) in the link data 410 shown in FIG. 21 as title (header), link (URL), and description (outline) in the update information.

The link-data receiving unit 520 retrieves a “header” of path information corresponding to information concerning the “title (header)” in the update information from the knowledge reference data 130a shown in FIG. 4. The link-data receiving unit 520 sets information concerning the “link (URL)” in the link information of the knowledge reference data 130a and sets information concerning the “description (outline)” in the outline of the knowledge reference data 130a in association with the “header”.

Consequently, when a request for dictionary retrieval of a certain item is received and semantic information corresponding to the matter, for which the request for dictionary retrieval is received, is displayed, it is possible to display items of a business webpage based on link information corresponding to the semantic information.

As described above, the dictionary server 500 receives, from the CMS 400 that stores address information concerning a business webpage in which a link to a retrieval site for semantic information is set, the address information and stores, based on the received address information, link information linked to information related to the semantic information in the storing unit 130 as the knowledge reference data 130a. Thus, it is possible to efficiently establish a link to a website and the like related to the semantic information using the information managed by the CMS 400.

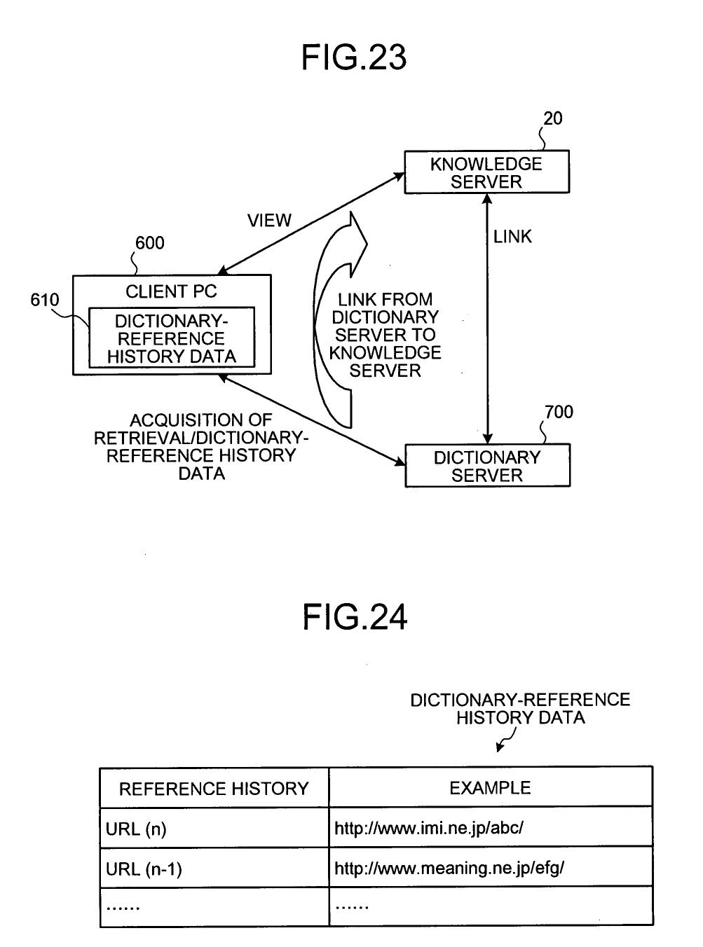

FIG. 23 is a schematic diagram of a dictionary retrieval system according to a fourth embodiment of the present invention. As shown in FIG. 23, the dictionary retrieval system includes a client PC 600, the knowledge server 20, and a dictionary server 700.

The dictionary server 700 displays, when a request for dictionary retrieval of a certain matter is received, a list of items of a business webpage based on semantic information and link information corresponding to the matter, for which the request for dictionary retrieval is received.

The dictionary server 700 acquires information concerning history in which a user accesses a retrieval site for semantic information set in a business webpage using link information concerning a link to the retrieval site and refers to the semantic information. The dictionary server 700 generates link information concerning a link from the semantic information to the business webpage based on address information of the business webpage included in the information concerning the history.

When a request for dictionary retrieval of a certain matter is received, the dictionary server 700 displays semantic information and a list of items of a business webpage corresponding to the matter, for which the request for dictionary retrieval is received.

The client PC 600 is used for accessing the dictionary server 700 or the knowledge server 20, requesting dictionary retrieval of a term, and viewing a business webpage related to semantic information of the term.

When a user accesses a retrieval site for semantic information set in a business webpage using link information concerning a link to the retrieval site for semantic information, the client PC 600 stores information concerning history of the access as reference-history data 610.

FIG. 24 is an example of the reference-history data 610 stored by the client PC 600. As shown in FIG. 24, in the reference-history data 610 is registered, as reference history, information concerning URLs (URL(n), URL(n-1), etc.) of a business webpage that the user viewed before accessing the retrieval site for semantic information using the link information.

For example, in the example of FIG. 24, “http://www.imi.ne.jp/abc/” is registered as information concerning the latest URL (URL(n)) and “http://www.meaning.ne.jp/efg/” is registered as information concerning an immediately preceding URL (URL(n-1)).

The dictionary server 700 stores therein semantic information and link information related to the semantic information in association with each other and displays, when a request for dictionary retrieval of a term is received from the client PC 600, items of a business webpage based on semantic information and link information corresponding to the request.

The dictionary server 700 acquires the reference-history data 610 from the client PC 600 and generates link information concerning a link from semantic information to a business webpage using the information concerning the URLs included in the reference-history data 610.

When a request for dictionary retrieval of a certain matter is received, the dictionary serer 700 displays, based on the generated link information, semantic information and a list of items of a business webpage corresponding to the matter, for which the request for dictionary retrieval is received. Since explanation concerning the knowledge server 20 is the same as that in the first embodiment, the explanation is omitted.

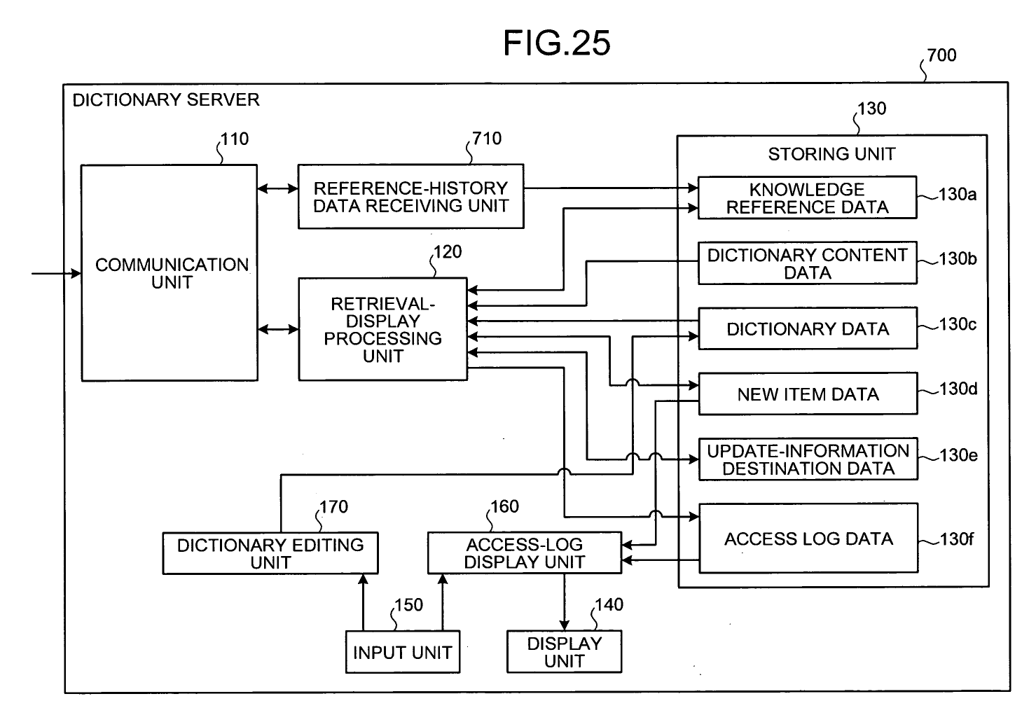

FIG. 25 is a functional block diagram of the dictionary server 700. The dictionary server 700 is of basically the same configuration as the dictionary server 100 except for a reference-history data receiving unit 710, and the same explanation is not repeated.

The reference-history data receiving unit 710 acquires the reference-history data 610 from the client PC 600 and sets the information concerning the URLs included in the reference-history data 610 as link information concerning a link from semantic information to a business webpage.

Specifically, the reference-history data receiving unit 710 acquires information concerning a URL from the reference-history data 610, accesses the knowledge server 20 that opens a business webpage corresponding to the URL, and acquires information concerning a heading and an outline of the business webpage.

However, when the client PC 600 stores the information concerning the header and the outline of the business webpage together with the URL, the reference-history data receiving unit 710 can acquire the information from the client PC 600.

The reference-history data receiving unit 710 generates, based on the information concerning the header and the outline, update information having a data structure same as that of the update information shown in FIG. 19 and updates the knowledge reference data 130a based on the generated update information.

The reference-history data receiving unit 710 sets the URL of the business webpage and the information concerning the header and the outline as “title (header)”, “link (URL)”, and “description (outline)” in the update information.

The reference-history data receiving unit 710 retrieves a “header” of path information corresponding to the information concerning the “title (header)” in the update information from the knowledge reference data 130a shown in FIG. 4. The reference-history data receiving unit 710 sets the information concerning the “link (URL)” in the link information of the knowledge reference data 130a and sets the information concerning the “description (outline)” in the outline of the knowledge reference data 130a in association with the “header”.

Consequently, when a request for dictionary retrieval of a certain item is received and semantic information corresponding to the matter, for which the request for dictionary retrieval is received, is displayed, it is possible to display items of a business webpage based on link information corresponding to the semantic information.

As described above, when a retrieval site for semantic information set in a business webpage is output based on link information concerning a link to the retrieval site for semantic information, the dictionary server 700 acquires address information of the business webpage and stores, based on the acquired address information, link information concerning a link to information related to the semantic information in the storing unit 130 as the knowledge reference data 130a. Thus, it is possible to efficiently establish a link to a business webpage and the like related to the semantic information using the address information of the business webpage at a link source at the time when the retrieval site for semantic information is output based on the link information.

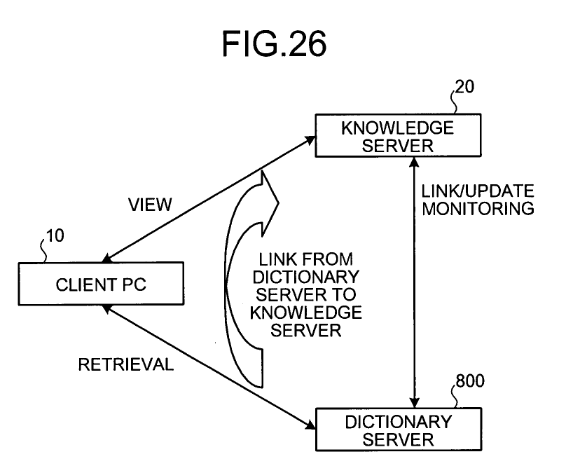

FIG. 26 is a schematic diagram of a dictionary retrieval system according to a fifth embodiment of the present invention. As shown in FIG. 26, the dictionary retrieval system includes the client PC 10, the knowledge server 20, and a dictionary server 800.

The dictionary server 800 displays, when a request for dictionary retrieval of a certain item is received, a list of items of a business webpage based on semantic information and link information corresponding to the item for which the request for dictionary retrieval is received.

The dictionary server 800 monitors an update state of a business webpage designated by a user and, when the business webpage is updated, acquires information concerning an updated item and generates link information concerning a link from semantic information to the business webpage based on words included in a heading and an outline corresponding to the item and a URL of the business webpage.

When a request for dictionary retrieval of a certain item is received, the dictionary server 800 displays, based on the generated link information, semantic information and a list of items of a business webpage corresponding to the matter, for which the request for dictionary retrieval is received.

The dictionary server 800 stores therein semantic information and link information related to the semantic information in association with each other and displays, when a request for dictionary retrieval of a term is received from the client PC 10, items of a business webpage based on semantic information and link information corresponding to the request.

The dictionary server 800 periodically accesses the knowledge server 20 that publishes a business webpage designated by the user, monitors an update state of the business webpage, and generates link information concerning a link from the semantic information to the business webpage based on information concerning an updated item.

When a request for dictionary retrieval of a certain item is received, the dictionary server 800 displays, based on the generated information, semantic information and a list of items of a business webpage corresponding to the matter, for which the request for dictionary search is received. The client PC 10 and the knowledge server 20 is basically similar to those previously described in the first embodiment, and the same explanation is not repeated.

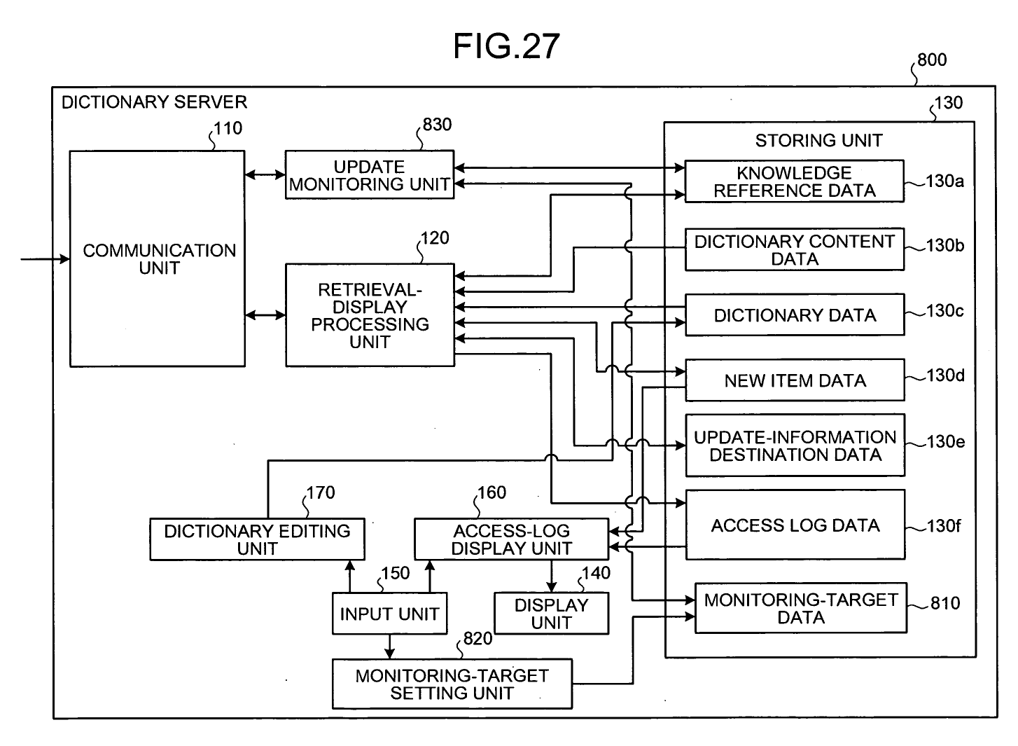

FIG. 27 is a functional block diagram of the dictionary server 800. The dictionary server 800 is of basically the same configuration as the dictionary server 100 except for a monitoring-target setting unit 820 and an update monitoring unit 830, and the same explanation is not repeated.

The storing unit 130 stores monitoring-target data 810 in addition to the knowledge reference data 130a, the dictionary content data 130b, the dictionary data 130c, the new item data 130d, the update-information destination data 130e, and the access log data 130f. The data stored in the storing unit 130 is the same as those previously described in connection with FIG. 2 except for the monitoring-target data 810, and the same explanation is not repeated.

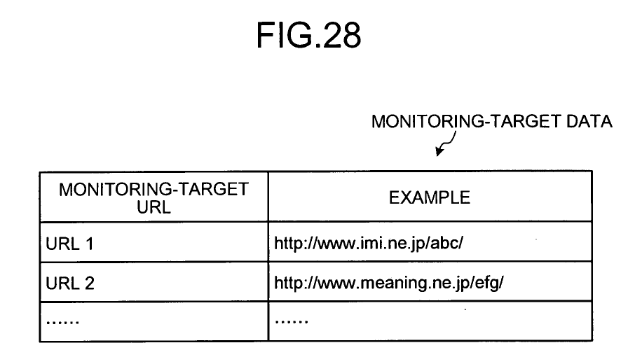

The monitoring-target data 810 is data in which information concerning a business webpage as an object of monitoring of an update state is registered. FIG. 28 is an example of a data structure of the monitoring-target data 810.

As shown in FIG. 28, information on “monitoring-target URL” is registered in the monitoring-target data 810. The “monitoring-target URL” is information concerning URLs (URL1, URL2, etc.) of the business webpage as an object of monitoring of an update state.

For example, in the example of FIG. 28, information concerning URLs such as “http://www.imi.ne.jp/abc/” and “http://www.meaning.ne.jp/efg/” is registered as the information concerning the “monitoring-target URL”.

The monitoring-target setting unit 820 acquires information concerning a URL of a business webpage as an object of monitoring of an update state input by the user via the input unit 150 and causes the storing unit 130 to store the information concerning the URL as the monitoring-target data 810.

The update monitoring unit 830 periodically checks the update state of the business webpage corresponding to the URL registered in the monitoring-target data 810 and generates link information concerning a link from semantic information to the business webpage based on information concerning an update item.

Specifically, the update monitoring unit 830 downloads information concerning the business webpage and compares the information with information downloaded last time to detect an updated item. The update monitoring unit 830 extracts words included in a header and an outline corresponding to the updated item and generates update information having a data structure same as that of the update information shown in FIG. 19.

The update monitoring unit 830 sets the URL, which registered in the monitoring-target data 810 shown in FIG. 28 as “monitoring-target URL”, and the information concerning the header and the outline, which is extracted from the updated item, as “link (URL)”, “title (header)”, and “description (outline)” in the update information shown in FIG. 19.

The update monitoring unit 830 retrieves a “header” of path information corresponding to information concerning the “title (header)” in the update information from the knowledge reference data 130a shown in FIG. 4. The update monitoring unit 830 sets information concerning the “link (URL)” in the link information of the knowledge reference data 130a and sets information concerning the “description (outline)” in the outline of the knowledge reference data 130a in association with the “header”.

Consequently, when a request for dictionary retrieval concerning a certain matter is received and semantic information corresponding to the matter, for which the request or dictionary retrieval is received, is displayed, it is possible to display items of a business webpage based on link information corresponding to the semantic information.

As described above, the dictionary server 800 monitors an update state of a designated business webpage and, when an updated business webpage is detected by the monitoring, detects address information of the updated business webpage, and stores, based on the detected address information, link information concerning a link to information related to semantic information in the storing unit 130 as the knowledge reference data 130a. Thus, it is possible to efficiently establish a link to a business webpage and the like related to the semantic information using the address information of the updated business webpage.

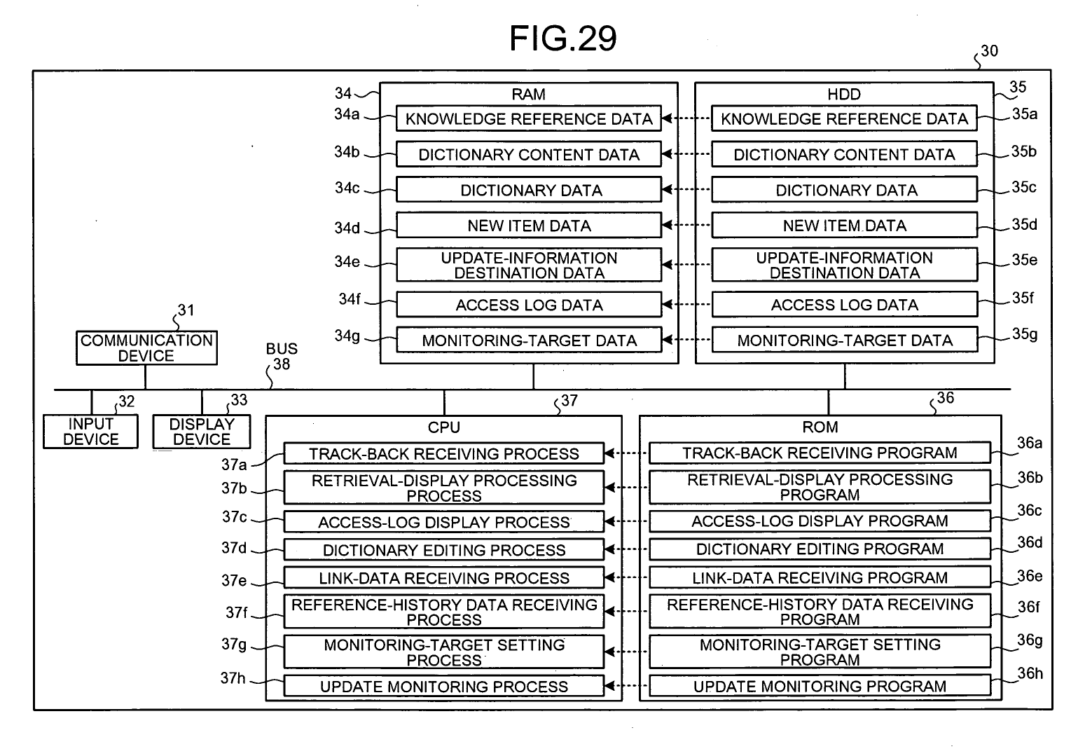

A computer program can be executed on a computer to realize the same function as the dictionary servers 100, 300, 500, 700, and 800. FIG. 29 is a schematic diagram of a computer 30 that executes such a computer program (hereinafter, “semantic retrieval program”).

The computer 30 includes a communication device 31, an input device 32, a display device 33, a RAM 34, a HDD 35, a ROM 36, and a CPU 37 connected by a bus 38. The communication device 31 corresponds to the communication unit 110 shown in FIG. 2, the input device 32 corresponds to the input unit 150 shown in FIG. 2, and the display device 33 corresponds to the display unit 140 shown in FIG. 2.

In the ROM 36 stores therein in advance the semantic retrieval program that implements the same function as any one of the servers 100, 300, 500, 700, and 800, i.e., a track-back receiving program 36a, a retrieval-display processing program 36b, an access-log display program 36c, a dictionary editing program 36d, a link-data receiving program 36e, a reference-history data receiving program 36f, a monitoring-target setting program 36g, an update monitoring program 36h.

The programs 36a to 36h can be integrated or distributed as appropriate in the same manner as the respective components of the dictionary servers 100, 300, 500, 700, and 800 shown in FIGS. 2, 17, 22, 25, and 27.

When the CPU 37 reads the programs 36a to 36h from the ROM 36 and executes them, as shown in FIG. 29, the programs 36a to 36h function as a track-back receiving process 37a, a retrieval-display processing process 37b, an access-log display process 37c, a dictionary editing process 37d, a link-data receiving process 37e, a reference-history data receiving process 37f, a monitoring-target setting process 37g, and an update monitoring process 37h, respectively.

The processes 37a to 37h correspond to the track-back receiving unit 310 shown in FIG. 17, the retrieval-display processing unit 120, the access-log display unit 160, and the dictionary editing unit 170 shown in FIGS. 2, 17, 22, 25, and 27, the link-data receiving unit 520 shown in FIG. 22, the reference-history data receiving unit 710 shown in FIG. 25, and the monitoring-target setting unit 820 and the update monitoring unit 830 shown in FIG. 27, respectively.

The HDD 35 stores therein, as shown in FIG. 29, knowledge reference data 35a, dictionary content data 35b, dictionary data 35c, new item data 35d, update-information destination data 35e, access log data 35f, and monitoring-target data 35g.

The data 35a to 35g correspond to the knowledge reference data 130a, the dictionary content data 130b, the dictionary data 130c, the new item data 130d, the update-information destination data 130e, and the access log data 130f shown in FIGS. 2, 17, 22, 25, and 27 and the monitoring-target data 810 shown in FIG. 27, respectively. The CPU 36 loads the respective data 35a to 35g to the RAM 34 and executes the semantic retrieval processing.

The respective programs 36a to 36h need not be necessarily stored in the ROM 36. The programs 36a to 36h can be stored in a portable physical medium such as a flexible disk (FD), a compact disk-read only memory (CD-ROM), a magneto-optical (MO) disk, a digital versatile (DVD) disk, and an IC card connectable to the computer 30. The programs 36a to 36h can also be stored in a fixed physical medium such as a hard disk (HD) provided on inside or outside the computer 30, or another computer (or a server) connected to the computer 30 through a public line, the Internet, a local area network (LAN), and a wide area network (WAN). The computer 30 can read the programs 36a to 36h from any of the above media and executes them.

As set forth hereinabove, according to an embodiment of the present invention, it is possible to improve business efficiency for the user. Moreover, the user can easily select desired link information, and efficiently establish a link to a website for particular information.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to execute:
storing link information on a link to information related to semantic information;
receiving a request for retrieval of semantic information related to an item;
retrieving the semantic information;
retrieving link information related to the semantic information; and
outputting the semantic information and the link information.

2. The computer-readable recording medium according to claim 1, wherein the outputting includes outputting first reference information for referring to the semantic information.

3. The computer-readable recording medium according to claim 2, wherein the outputting further includes outputting second reference information for referring to semantic information related to the item stored in another apparatus.

4. The computer-readable recording medium according to claim 1, wherein
the item is a term; and
the link information includes attribute information including a synonym and an antonym for the term, a related term of the term, and a usage example of the term.

5. The computer-readable recording medium according to claim 1, further causing the computer to execute:
reporting that semantic information related to the item is not found when no semantic information related to the item is found; and
storing, when semantic information related to the item is found, the semantic information.

6. The computer-readable recording medium according to claim 1, further causing the computer to execute:
storing information on a source of the request; and
notifying, when the semantic information is updated, the source of update semantic information.

7. The computer-readable recording medium according to claim 1, further causing the computer to execute:
acquiring track-back information for establishing a link to information related to the semantic information; and
converting the track-back information to link information.

8. The computer-readable recording medium according to claim 1, further causing the computer to execute receiving address information on a site to which a link is provided from a site from which the semantic information is retrieved, wherein
the storing includes storing the link information based on the address information.

9. The computer-readable recording medium according to claim 1, further causing the computer to execute acquiring address information on a site in which link information is provided for a site from which the semantic information is retrieved, wherein
the storing includes storing the link information based on the address information.

10. The computer-readable recording medium according to claim 1, further causing the computer to execute:
monitoring update of a designated site; and
acquiring address information on the designated site when the designated site is updated, wherein
the storing includes storing the link information based on the address information.

11. A semantic retrieval method comprising:
storing link information on a link to information related to semantic information;
receiving a request for retrieval of semantic information related to an item;
retrieving the semantic information;
retrieving link information related to the semantic information; and
outputting the semantic information and the link information.

12. The semantic retrieval method according to claim 11, wherein
the item is a term; and
the link information includes attribute information including a synonym and an antonym for the term, a related term of the term, and a usage example of the term.

13. The semantic retrieval method according to claim 11, further causing the computer to execute:
reporting that semantic information related to the item is not found when no semantic information related to the item is found; and
storing, when semantic information related to the item is found, the semantic information.
